(19) United States
(12) Patent Application Publication
(10) Pub. No.: US 2009/0025261 A1
(43) Pub. Date: Jan. 29, 2009

(54) Storage Car

(75) Inventor: Jorg Ganz, Etoy (CH)

Correspondence Address: LERNER GREENBERG STEMER LLP, P O BOX 2480, HOLLYWOOD, FL, 33022-2480, US

(73) Assignee: MATISA MATERIEL INDUSTRIEL SA, Crissier-Lausanne (CH)

(21) Appl. No.: 12/248,439

(22) Filed: Oct. 9, 2008

Related U.S. Application Data
(63) Continuation of application No. PCT/IB2007/000416, filed on Feb. 20, 2007.

(30) Foreign Application Priority Data
Apr. 10, 2006 (CH) 0059006

(51) Int. Cl. B60P 1/36

(52) U.S. Cl. 37/305

(57) ABSTRACT

A storage car for storing bulk material contains a car chassis which may be optionally supported on rail-bound carriages or non-rail-bound carriages. A floor conveyor belt, runs in a car longitudinal direction and is disposed in a storage container. A transfer conveyor belt is disposed at an angle extending over a front end of the car chassis. At a rear end of the floor conveyor belt with relation to a transport direction, the storage car has an excavator device for picking up and removing the bulk material onto the floor conveyor belt. The excavator device is arranged outside the storage container and contains an adjustable grab operated by actuators. The excavator device further contains a take-up conveyor belt with a low take-up end and an ejection end positioned above the floor conveyor belt.

### CROSS-REFERENCE TO RELATED APPLICATION

This is a continuing application, under 35 U.S.C. §120, of copending international application PCT/IB2007/000416, filed Feb. 20, 2007, which designated the United States; this application also claims the priority, under 35 U.S.C. § 119, of Swiss patent application No. 0059006, filed Apr. 10, 2006; the prior applications are herewith incorporated by reference in their entirety.

### BACKGROUND OF THE INVENTION

### Field of the Invention

The invention relates to a storage car, for storing bulk material. The storage car has a car chassis, which may be supported according to choice on railbound or on non-railbound carriages, and a floor conveyor belt, which runs in the longitudinal direction of the car and is disposed in a storage container. The storage car further has a transfer conveyor belt, which is disposed at an angle and projects over a front end of the car chassis, and an excavating device for taking up and for discharging the bulk material onto the floor conveyor belt.

A storage car of this type is already known from published, non-prosecuted German patent application DE 196 23 940 A1, corresponding to U.S. Pat. No. 5,727,474. The excavating device of this two-way-movable storage car is configured as a clearing chain, as is also used in connection with cleaning machines for track beds. A take-up end of the clearing chain is disposed beneath the floor conveyor belt between the rail carriages. A discharge end of the clearing chain is positioned above a floor conveyor belt disposed in a storage container. A storage car of this type can be used, particularly in the trackless sphere, without an additional excavator. For an effective use of the clearing chain, a constant movement of the storage car in the working direction is necessary.

### BRIEF SUMMARY OF THE INVENTION

It is accordingly an object of the invention to provide a storage car which overcomes the above-mentioned disadvantages of the prior art devices of this general type, which, by constructively simple measures, can be used particularly efficiently in excavation works, especially in small reconstruction gaps.

With the foregoing and other objects in view there is provided, in accordance with the invention, a storage car for storing bulk material. The storage car contains railbound carriages and/or non-railbound carriage. A car chassis is supported according to choice on the railbound carriages or the non-railbound carriages. The car chassis further has a front end and a rear end. A floor conveyor belt runs in a longitudinal direction of the storage car and is disposed in the storage container. A transfer conveyor belt is disposed at an angle and projects over the front end of the car chassis. An excavating device is provided for taking up and for discharging the bulk material onto the floor conveyor belt. The excavating device is disposed outside the storage container at the, with respect to a transport direction of the floor conveyor belt, rear end of the car chassis. The excavating device is formed of drives, a digging member being adjustable by the drives, and a take-up conveyor belt positioned at the rear end of the car chassis. The take-up conveyor belt has a lower-lying take-up end and a discharge end positioned above the floor conveyor belt.

According to the invention, the object is achieved with a storage car of the type stated in the introduction that has the excavating device disposed outside the storage container at a, with respect to a transport direction of the floor conveyor belt, rear end of the car chassis and is formed of a digging member, which is adjustable by drives, and of a take-up conveyor belt, which is positioned at the rear end of the car chassis and has a lower-lying take-up end and a discharge end positioned above the floor conveyor belt.

With this configuration, excavation works can already be performed while the storage car itself is still on the track directly in front of the reconstruction gap to be treated. The excavating device is flexibly configured such that, with just a few driving maneuvers of the storage car, each point on the reconstruction gap can be treated. A repeated, time-consuming and cost-intensive moving of the storage car to reposition of the excavating device can thereby be avoided. Moreover, the use of the excavating device is not dependent on the continuous advance of the storage car.

Other features which are considered as characteristic for the invention are set forth in the appended claims.

Although the invention is illustrated and described herein as embodied in a storage car, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, side view of a storage car;

FIG. 2 is a diagrammatic, top view of a part of the storage car; and

FIGS. 3 to 6 are diagrammatic, partial side views of further variants of storage cars.

### DETAILED DESCRIPTION OF THE INVENTION

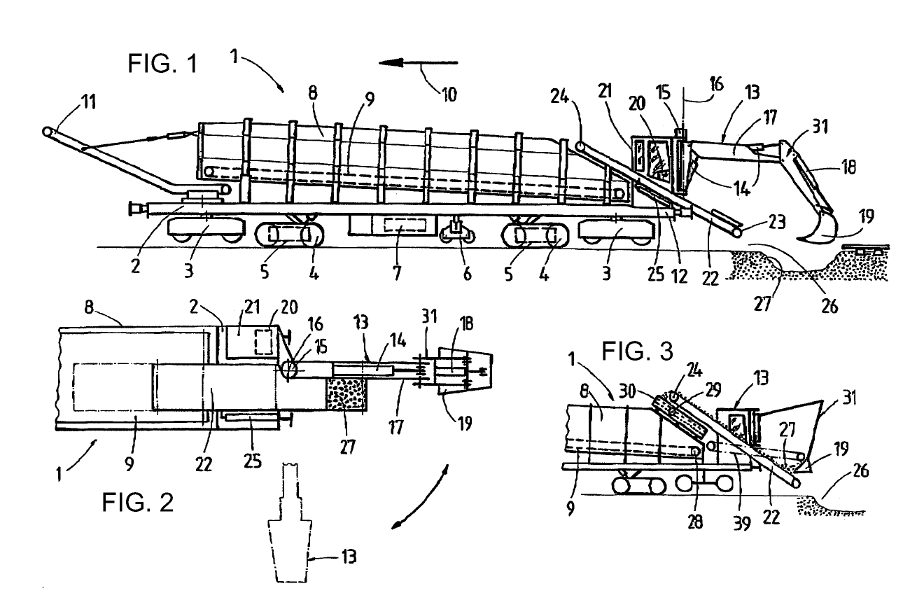

Referring now to the figures of the drawing in detail and first, particularly, to FIG. 1 thereof, there is shown a storage car 1 that has a car chassis 2, which, at the end side, can be supported on rail carriages 3. Between these there are located two height-adjustable, non-railbound carriages 4, provided with transport drives 5. In addition, the car chassis 2 has an auxiliary carriage 6, for derailing and rerailing the storage car 1, and a power unit 7 for powering all the drives.

On the car chassis 2 there is disposed a storage container 8, in a bottom region of which there is positioned a floor conveyor belt 9 running in a longitudinal direction of the car. Before the floor conveyor belt 9, in a transport direction 10, a transfer conveyor belt 11 is provided. This is arranged at an angle relative to the floor conveyor belt 9 and is configured to project over the car chassis 2. At a, with respect to the transport direction 10, rear end 12 of the car chassis 2—outside the storage container 8—an excavating device 13 is provided.

As can also be seen in FIG. 2, the excavating device 13 has a digging member 31, which is disposed on a boom 17 adjustable by drives 14, 15 and rotatable about a vertical axis 16, and consists of a bucket 19 movable by a working drive 18. To the excavating device 13 there is additionally assigned a work cab 21, which is equipped with a control system 20 and from which the storage car 1 and the extraction device 13 are maneuvered during working use. One position of the excavating device 13, pivoted laterally alongside the track, is indicated by dash-dot lines in FIG. 2.

To the excavating device 13 there is further assigned a take-up conveyor belt 22 disposed at the rear end 12 of the car chassis 2. This has a lower-lying take-up end 23 and a discharge end 24 situated above the floor conveyor belt 9. The take-up end 23 is disposed, with respect to the vertical, beneath the car chassis 2. With the aid of a drive 25, the take-up conveyor belt 22 is brought from an operating setting into a shutdown setting (shown in dash-dot representation in FIG. 2).

In working use, the storage car 1 is first moved on the rail carriages 3 to a reconstruction gap 26. After this, the take-up conveyor belt 22 is brought into the operating setting. If need be, the excavating device 13 can already at this point remove bulk material 27 from the reconstruction gap 26. Otherwise, the storage car 1 is maneuvered into the reconstruction gap 26 by moving and lowering of the non-railbound carriages 4. Through actuation of the drives 14, 15 and of the working drive 18, bulk material 27 is taken up by the bucket 19 and discharged onto the take-up end 23 of the take-up conveyor belt 22. From there, the bulk material 27 is transported into the storage container 8 and stored there.

In a variant of the storage car 1 represented in FIG. 3, beneath the discharge end 24 of the take-up conveyor belt 22 and above a take-up end 28 of the floor conveyor belt 9, there is disposed a screen 30 attached to the storage container 8 and provided with a drive 29. Thus the bulk material 27 can be cleaned and—following discharge by the transfer conveyor belt 11 (FIG. 1)—is immediately available again for reuse. The screen 30 can also, of course, be loaded directly from the excavating device 13. The excavating device 13 can also be used to take up the spoil formed during screening of the bulk material 27 and to deposit it outside the reconstruction gap 26. Via a conveyor belt 39 indicated in dash-dot representation, the bulk material 27 can also be fed into the reconstruction gap 26 directly from the sieve 30.

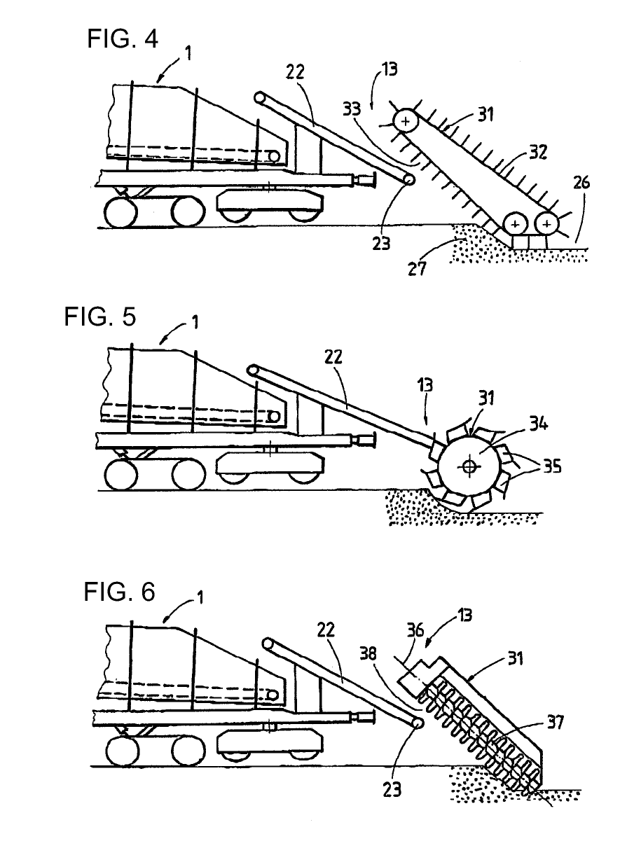

The digging member 31 represented in FIG. 4 consists of a continuous conveyor chain 32. This has a discharge end 33 positioned above the take-up end 23 of the take-up conveyor belt 22.

As can be seen in FIG. 5, the digging member 31 can also be formed of a rotatable bucket wheel 34 having a multiplicity of buckets 35.

The digging member 31 according to FIG. 6 is configured as a feed screw 37 rotatable about an axis 36. The discharge end 38 thereof is positioned above the take-up end 23 of the take-up conveyor belt 22.

1. A storage car for storing bulk material, comprising:
carriages selected from the group consisting of railbound carriages and non-railbound carriages;
a car chassis supported according to choice on one of said railbound carriages and said non-railbound carriages, said car chassis having a front end and a rear end;
a storage container;
a floor conveyor belt running in a longitudinal direction of the storage car and disposed in said storage container;
a transfer conveyor belt disposed at an angle and projecting over said front end of said car chassis; and
an excavating device for taking up and for discharging the bulk material onto said floor conveyor belt, said excavating device disposed outside said storage container at said, with respect to a transport direction of said floor conveyor belt, rear end of said car chassis, said excavating device formed of drives, a digging member being adjustable by said drives, and a take-up conveyor belt positioned at said rear end of said car chassis, said take-up conveyor belt having a lower-lying take-up end and a discharge end positioned above said floor conveyor belt.

2. The storage car according to claim 1, wherein said digging member has a boom and a bucket fastened on said boom, said boom is adjusted by said drives and rotatable about a vertical axis.

3. The storage car according to claim 1, wherein said digging member is formed as a continuous conveyor chain having a discharge end positioned above said lower-lying take-up end of said take-up conveyor belt.

4. The storage car according to claim 1, wherein said digging member has a rotatable bucket wheel with a multiplicity of buckets.

5. The storage car according to claim 1, wherein said digging member has a feed screw rotatable about an axis, said feed screw having a discharge end positioned above said lower-lying take-up end of said take-up conveyor belt.

6. The storage car according to claim 1, further comprising a work cab having a control system assigned to said excavating device.

7. The storage car according to claim 1, wherein said lower-lying take-up end of said take-up conveyor belt is placed, with respect to a vertical, beneath said car chassis.

8. The storage car according to claim 1, further comprising a drive for adjusting said take-up conveyor belt between an operating setting and a shutdown setting.

9. The storage car according to claim 1,
wherein said floor conveyor belt has a take-up end; and
further comprising a screen having a drive for the bulk material, said screen disposed above said take-up end of said floor conveyor belt.
